(19) United States
(12) Patent Application Publication
(10) Pub. No.: US 2025/0116114 A1
(43) Pub. Date: Apr. 10, 2025

(54) EXTENDABLE DRAINPIPE ASSEMBLY

(71) Applicant: Shenzhen Ruichenxi Technology Co., Ltd., Shenzhen (CN)

(72) Inventor: Xi ZHANG, Shenzhen (CN)

(21) Appl. No.: 18/986,992

(22) Filed: Dec. 19, 2024

Related U.S. Application Data
(62) Division of application No. 18/764,728, filed on Jul. 5, 2024.
Application No. 18/764,728 is a continuation-in-part of application No. 18/392,574, filed on Dec. 21, 2023.
Application No. 18/392,574 is a continuation-in-part of application No. 18/088,722, filed on Dec. 26, 2022, now Pat. No. 11,885,441.

(51) Int. Cl. F16L 27/12

(52) U.S. Cl. CPC E04D 13/08; F16L 11/15; E04D 2013/0813; E04D 2013/0846

(57) ABSTRACT

The present application relates to an extendable drainpipe assembly, which comprises a pipe body and a first pipe connector, the first pipe connector comprises at least a first connecting structure, and the pipe body comprises at least a second connecting structure and at least a fold, the first connecting structure is mountably and removably connected to the second connecting structure, the fold have two sidewalls set opposite each other, the fold is expandable through the two side walls capable of unfolding into a threaded shape.

### CROSS-REFERENCE TO RELATED APPLICATIONS

This application is a a Divisional of U.S. Ser. No. 18/764,728, filed Jul. 5, 2024, which is a Continuation-In-Part application of U.S. patent application Ser. No. 18/392,574, filed on Dec. 21, 2023, which is a Continuation-In-Part application of U.S. patent application Ser. No. 18/088,722, filed on Dec. 26, 2022, which claims priority to Chinese Patent Application No. 202223355007.4, filed Dec. 12, 2022, each of which is entirely incorporated herein by reference.

### TECHNICAL FIELD

The present application relates to the technical field of drain technology, and in particular, to an extendable drainpipe assembly.

### BACKGROUND

The elastic drainpipes currently in the market are usually formed by blow molding the expandable pipe body and the adapter into an integrated whole. When there is a need to use different lengths of drainpipe, both the expandable body and the adapter need to be remanufactured, resulting in the need to design and manufacture a new mold for the expandable body and a new mold for the adapter. Furthermore, during the use of the drainpipe, the expandable pipe body, adapter, and connecting part between the adapter and the expandable pipe body of the drainpipe are all possibly to be damaged, and since the expandable pipe body is usually fixed to the adapter, when just one of the expandable pipe body, the adapter, and the connecting part between the adapter and the expandable pipe body is damaged the expandable pipe body and the adapter need to be scrapped together, which results in the use of the cost being increased significantly. Thus, the current drainpipe design is costly and not so convenient for recycling.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, an extendable drainpipe assembly is provided, comprising: a pipe body and a first pipe connector, the first pipe connector comprises at least a first connecting structure, and the pipe body comprises at least a second connecting structure and a fold, the first connecting structure is mountably and removably connected to the second connecting structure, the fold have two sidewalls set opposite each other, the two sidewalls are selectively expanded into a thread.

The above aspects or examples and advantages, as well as other aspects or examples and advantages, will become apparent from the ensuing description and accompanying drawings.

### BRIEF DESCRIPTION OF THE DRAWINGS

The drawings of the specification that form a part of the present application, are used to provide a further understanding of present the application. Schematic embodiments and their descriptions of the present application are used to explain the application and do not constitute an improper limitation of the present application. In the drawings:

FIG. 1 shows a schematic diagram of a part of an extendable drainpipe assembly in an extended and connected state of another embodiment;

FIG. 2 shows a schematic diagram of the extendable drainpipe assembly shown in FIG. 1 in an extended and separated state; and

FIG. 3 shows a schematic diagram of a first adapter of the extendable drainpipe assembly shown in FIG. 1.

### DETAILED DESCRIPTION OF THE EMBODIMENTS

The present application will be described in detail below with reference to the drawings and in combination with embodiments. Various examples are provided by way of interpretation of the present application rather than limiting the present application. In fact, those skilled in the art will know that modifications and variations can be made to the present application without departing from the scope or spirit of the present application. For example, features shown or described as part of one embodiment may be used in another embodiment to generate another embodiment. It is therefore desirable that the present application includes such modifications and variations that fall within the scope of the appended claims and their equivalents.

In the description of the present application, the terms “longitudinal”, “latitudinal”, “up”, “down”, “front”, “rear”, “left”, “right”, “vertical”, “horizontal”, “top”, “bottom”, etc. indicate the orientation or positional relationship based on the drawings, which is only for the convenience of describing the present application rather than requiring the present application to be constructed and operated in a specific orientation, Therefore, it cannot be understood as a limitation of the present application. The terms “connected”, “connection” and “configure” used in the present application should be understood in a broad sense, for example, it can be a fixed connection or a detachable connection; it can be a direct connection or an indirect connection through an intermediate part; it can be a wired electrical connection, a radio connection, or a wireless communication signal connection. For those skilled in the art, the specific meaning of the above terms can be understood according to the specific situation.

One or more examples of the present application are shown in the drawings. The detailed description uses numerals and letter markers to refer to features in the drawings. Similar or like numerals in the drawings and descriptions have been used to refer to similar or like parts of the present application. As used herein, the terms “first”, “second”, and “third” are used interchangeably to distinguish one component from another and are not intended to indicate the location or importance of individual components.

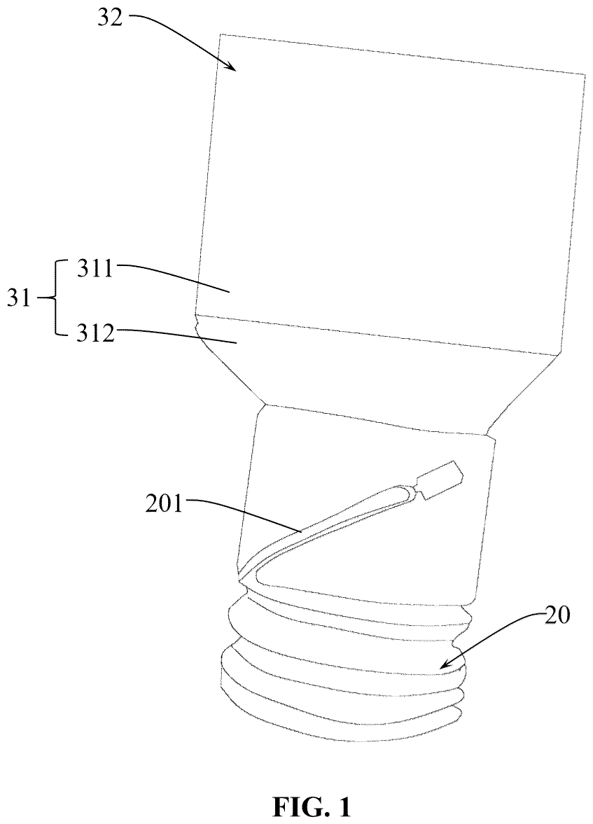

This embodiment provides an extendable drainpipe assembly 100, referring to FIG. 1 to FIG. 3, the extendable drainpipe assembly 100 comprises a spiral-shaped and expandable pipe body 20 and a first adapter 30 connected to one end of the pipe body 20, which is made of a material with a certain degree of elasticity, and the first adapter 30 is connected to an external drainage when in use. The pipe body 20 can be manufactured to an actual length and actual size according to actual needs, to adapt to more flexible and variable needs.

In this embodiment, the first adapter 30 comprises a hollow first adapter seat 31 and a first pipe connector 32 connected to the first adapter seat 31, the first pipe connector 32 comprises at least a first connecting structure 321, the pipe body 20 comprises at least a second connecting structure 201 and multiple folds, the pipe body 20 is spiral-shaped, the first connecting structure 321 is mountably and removably connected to the second connecting structure 201 of the pipe body 20.

In this embodiment, the fold has two annular sidewalls 10 set opposite each other, when the extendable drainpipe assembly 100 is in a extended and separated state, the two sidewalls 10 are unfolded into a V-shaped thread, thus the length of the extendable drainpipe assembly 100 can be adjusted as required during use. When the extendable drainpipe assembly 100 is in a compressed state, the two sidewalls 10 are folded against each other and the pipe body 20 can be compressed for storage. The pipe body 20 can be expanded when the length of the extendable drainpipe assembly 100 is not enough; and the pipe body 20 can be compressed for storage when the length of the extendable drainpipe assembly 100 is too long for storage, for convenient storage.

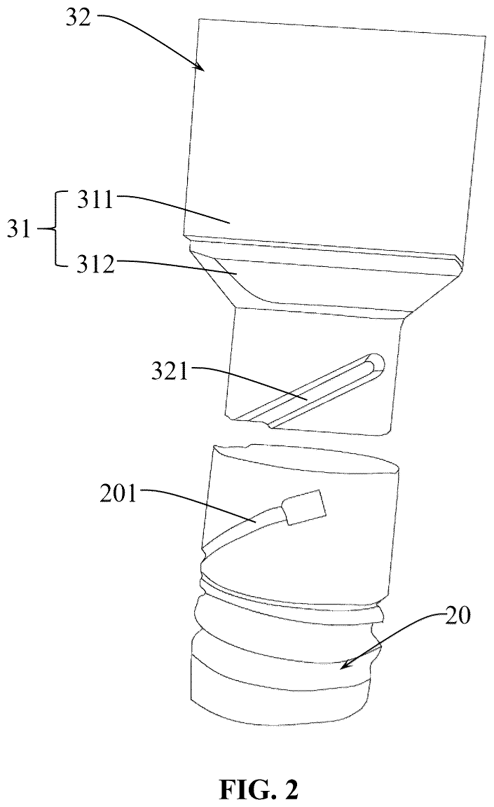

Referring to FIG. 1 and FIG. 2, the first connecting structure 201 comprises a first protrusion, the first protrusion extends along a spiral path surrounding the first pipe connector 32, the second connecting structure 201 comprises a second slot in which the first protrusion is stuck.

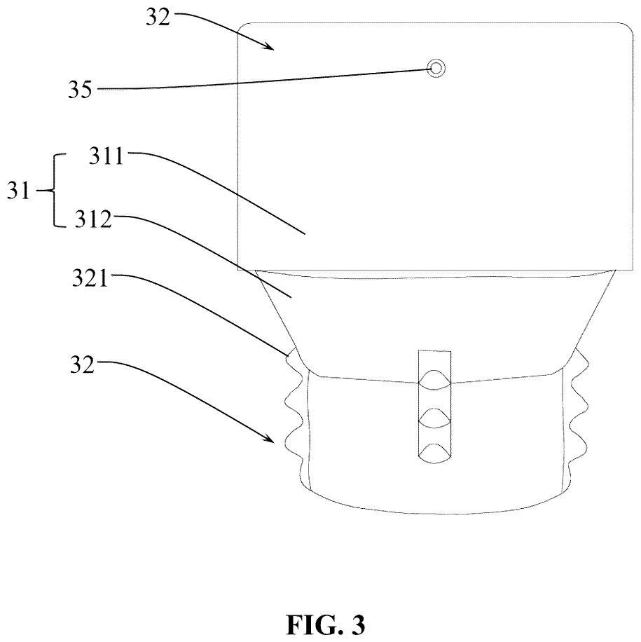

Referring to FIG. 3, the first connecting structure 201 comprises multiple protrusions, wherein the protrusions are arranged in a spiral path surrounding the first pipe connector; when the fold is expanded through the two side walls unfolding into a threaded shape, the protrusions are capable of screwing into the threaded shape along the spiral path.

In this embodiment, the first connecting structure 321 is distributed along a spiral path continuously and circumferentially in the sidewall of the first pipe connector 32, the second connecting structure 201 is distributed along a spiral path continuously and circumferentially in the sidewall of the pipe body 20; it is understandable that, in some embodiments, multiple first connecting structures 321 are spaced apart from each other and distributed along a spiral path circumferentially in the sidewall of the first pipe connector 32, multiple second connecting structures 201 are spaced apart from each other and distributed along a spiral path circumferentially in the sidewall of the pipe body 20.

When the extendable drainpipe assembly 100 is in a extended and connected state, the first adapter 30 is mountably and removably installed in screwed connection to the pipe body 20. The structure of the extendable drainpipe assembly 100 is reasonable and easy to disassemble and assemble, the pipe body 20 is convenient for replacing if needed, and the first adapter 30 can be reused if needed, which effectively reduces the cost of use. Wherein the first pipe connector 32 can be screwed into the pipe body 20 via the V-shaped thread during installation to complete the assembly, and during disassembling, it just needs to be screwed out along the original path. The installation and disassembly are efficient and convenient, without the need to use glue to strengthen the fixation (which cannot be disassembled), and there is no need for an intermediate structure with threads between the first adapter 32 and the pipe body 20, to reduce the cost and simplify the structure.

In this embodiment, the first pipe connector 32 is made of hard material and cannot be expanded and compressed, so that the pipe body 20 can be firmly installed on the first pipe connector 32. The first pipe connector 32 works well for installation and support, so the pipe body 20 is not easy to loosen and disconnect from the first pipe connector 32. For easy storage, in some embodiments, the first pipe connector 32 is made of expandable material so that when the extendable drainpipe assembly 100 is in the compressed state, the two sidewalls 10 of the first connecting structure 321 of the first pipe connector 32 are folded against each other and the first pipe connector 32 can also be compressed to reduce the occupied space for easy storage, when the extendable drainpipe assembly 100 is in the extended and separated state, the two sidewalls 10 is expanded into a V-shaped thread, and the second connecting structure 201 is also expanded into a V-shaped thread, and when the extendable drainpipe assembly 100 is in the extended and connected state, the first adapter 30 is capable of being installed in screwed connection to the pipe body 20 through the V-shaped thread.

In this embodiment, the radial diameter of the first pipe connector 32 is slightly smaller than that of the pipe body 20 so that when assembling, the outer wall of the first pipe connector 32 is abutted against the inner wall of the pipe body 20. It is understandable that, in some embodiments, the radial diameter of the first pipe connector 32 is slightly larger than that of the pipe body 20 so that when assembling, the inner wall of the first pipe connector 32 is butted against the outer wall of the pipe body 20.

In this embodiment, the first adapter seat 31 is provided with at least two first grooves 33, and the first groove 33 is located on an outer wall of the first adapter seat 31 so that the first adapter seat 31 can be jammed and installed onto the drainage of a house by the first groove 33. A plurality of first grooves 33 are symmetrically arranged on the first adapter seat 31, which can ensure that the first adapter seat 31 won't fall off along the axial direction of the drainpipe after installation.

In this embodiment, the first adapter seat 31 is provided with at least one first leak-proof gasket 34, and the first leak-proof gasket 34 is arranged around the outer wall of the first adapter seat 31 so that the first adapter seat 31 will abut against an inner wall of the drainage of the house after being jammed and installed onto the drainage of the house to provide a leak-proof sealing. The first leak-proof gasket 34 is located about one end of the first adapter seat 31 away from the first pipe connector 32. In this embodiment, two first leak-proof gaskets 34 are provided so that a double sealing may be formed, providing a better leak-proof sealing effect.

In this embodiment, the first adapter seat 31 is provided with a locking adapter 35, and the locking adapter 35 is located on the outer wall of the first adapter seat 31 so that the adapter seat 31 can be locked with the drainage of the house by screws during installation, which further ensures the stability of installation and connection. In this embodiment, two locking adapters 35 are provided, symmetrically arranged on the first adapter seat 31, so that the locking force is evenly distributed and the configuration is reasonable.

In this embodiment, the first adapter seat 31 comprises a first rectangular portion 311 and an interconnected first horn portion 312 with the first rectangular portion 311, the first horn portion 312 is connected with the first pipe connector 32, and the first rectangular portion 311 can prevent the first adapter seat 31 from loosening after installation on the drainage of the house due to the rotation of the first adapter seat 31 along the circumference of the drainage. Moreover, the space of the first rectangular portion 311 is larger than that of the first horn portion 312, so that via the first rectangular portion 311 the capacity for containing water is increased to make it easier for water to flow from the drainage of the house into the first rectangular portion 311, and the first horn portion 312 provides a guide to the flow of water to make it easier for water to enter the pipe body 20. In this embodiment, the number of first groove 33 is four, two first grooves 33 as a group, and two groups of the first groove 33 are respectively located on two oppositely disposed outer walls of the first rectangular portion 311. In other embodiments, the first adapter seat 31 can also be other hollow shapes, such as circular tubular shape, pentagonal tubular shape, etc., which is not limited herein.

It is understandable that, in some embodiments, the extendable drainpipe assembly 100 further comprises a second adapter connected to another end of the pipe body 20, the second adapter and first adapter 30 have similar structures and work in similar ways.

The above embodiments only described several embodiments of the present application, and the description is relatively specific and detailed, but it cannot be understood as a limitation to the scope of the present application patent. It should be noted that for a person of ordinary skill in the art, a number of variations and improvements can be made without departing from the conception of the present application, and these variations and improvements fall within the scope of protection of the present application. Therefore, the scope of protection of the present application patent shall be subject to the appended claims.

1. An extendable drainpipe assembly, comprising: a pipe body and a first pipe connector, the first pipe connector comprises at least a first connecting structure, and the pipe body comprises at least a second connecting structure and at least a fold, the first connecting structure is mountably and removably connected to the second connecting structure, the fold have two sidewalls set opposite each other, the fold is expandable through the two side walls capable of unfolding into a threaded shape.

2. The extendable drainpipe assembly according to claim 1, further comprises a first adapter seat connecting the first pipe connector, wherein the first adapter seat is provided with at least two first grooves, and the first groove is located on an outer wall of the first adapter seat.

3. The extendable drainpipe assembly according to claim 2, wherein the first adapter seat is provided with at least one first leak-proof gasket and the first leak-proof gasket is arranged around an outer wall of the first adapter seat.

4. The extendable drainpipe assembly according to claim 3, wherein the first leak-proof gasket is provided at one end of the first adapter seat away from the first pipe connector.

5. The extendable drainpipe assembly according to claim 2, wherein the first adapter seat is provided with a locking adapter, and the locking adapter is located on the outer wall of the first adapter seat.

6. The extendable drainpipe assembly according to claim 2, wherein the first adapter seat comprises a first rectangular portion and a first horn portion which is interconnected with the first rectangular portion, and the first horn portion is connected with the first pipe connector.

7. The extendable drainpipe assembly according to claim 1, wherein the first pipe connector is made of expandable material.

8. An extendable drainpipe assembly, comprising: a pipe body and a first pipe connector, the first pipe connector comprises a first protrusion or a first slot, the first protrusion or the first slot extends along a spiral path surrounding the first pipe connector, the pipe body comprises at least a fold and a second slot in which the first protrusion is stuck or a second protrusion stuck in the first slot, the fold has two sidewalls set opposite each other, the fold is expandable through the two side walls capable of unfolding into a threaded shape.

9. The extendable drainpipe assembly according to claim 8, further comprises a first adapter seat connecting the first pipe connector, wherein the first adapter seat is provided with at least two first grooves, and the first groove is located on an outer wall of the first adapter seat.

10. The extendable drainpipe assembly according to claim 9, wherein the first adapter seat is provided with at least one first leak-proof gasket and the first leak-proof gasket is arranged around an outer wall of the first adapter seat.

11. The extendable drainpipe assembly according to claim 10, wherein the first leak-proof gasket is provided at one end of the first adapter seat away from the first pipe connector.

12. The extendable drainpipe assembly according to claim 9, wherein the first adapter seat is provided with a locking adapter, and the locking adapter is located on the outer wall of the first adapter seat.

13. The extendable drainpipe assembly according to claim 9, wherein the first adapter seat comprises a first rectangular portion and a first horn portion which is interconnected with the first rectangular portion, and the first horn portion is connected with the first pipe connector.

14. The extendable drainpipe assembly according to claim 8, wherein the first pipe connector is made of expandable material.

15. An extendable drainpipe assembly, comprising: a pipe body and a first pipe connector, wherein the first pipe connector comprises multiple protrusions, the protrusions are arranged in a spiral path surrounding the first pipe connector, the pipe body comprises a fold, the fold has two sidewalls set opposite each other, the fold is expandable through the two side walls capable of unfolding into a threaded shape into which the protrusions is capable of screwing into along the spiral path.

16. The extendable drainpipe assembly according to claim 15, further comprises a first adapter seat connecting the first pipe connector, wherein the first adapter seat is provided with at least two first grooves, and the first groove is located on an outer wall of the first adapter seat.

17. The extendable drainpipe assembly according to claim 16, wherein the first adapter seat is provided with at least one first leak-proof gasket and the first leak-proof gasket is arranged around an outer wall of the first adapter seat.

18. The extendable drainpipe assembly according to claim 17, wherein the first leak-proof gasket is provided at one end of the first adapter seat away from the first pipe connector.

19. The extendable drainpipe assembly according to claim 15, wherein the first adapter seat is provided with a locking adapter, and the locking adapter is located on the outer wall of the first adapter seat.

20. The extendable drainpipe assembly according to claim 15, wherein the first adapter seat comprises a first rectangular portion and a first horn portion which is interconnected with the first rectangular portion, and the first horn portion is connected with the first pipe connector.
